(19) United States
(12) Patent Application Publication
(10) Pub. No.: US 2006/0191007 A1
(43) Pub. Date: Aug. 24, 2006

(54) Security force automation

(76) Inventor: Sanjiva Thielamay, Clayton, CA (US)

Correspondence Address: Patel & Alumit, P.C., Suite 302, 20121 Ventura Blvd., Woodland Hills, CA, 91364, US

(21) Appl. No.: 11/066,816

(22) Filed: Feb. 24, 2005

(51) Int. Cl. G06F 12/14

(52) U.S. Cl. 726/22

(57) ABSTRACT

An automated security monitoring and management framework which mimics the mind of a seasoned security expert and which is designed to provide security management, governance and compliance with business context risk assessment is described. The framework comprises of a central management center and a plurality of modules, whereby said framework has the ability to incorporate all security mechanisms into one cohesive solution. Our approach in management eliminates the human factor providing consistent, repeatable and scalable result in the enterprise. It is an agent-less, vendor-agnostic framework that is constantly working to maintain security and governance. Moreover, said framework is capable of correlating alerts and events from disparate systems providing a global view of one's security status, and hence acts as a system that helps in identifying the patterns of threats as they develop. The framework simulates the tasks of a security engineer and automates a day in the life cycle of a security engineer.

### CROSS-REFERENCE TO RELATED APPPLICATION

None

### FEDERALLY SPONSORED RESEARCH

Not Applicable

### SEQUENCE LISTING OR PROGRAM

Not Applicable

### BACKGROUND

The present invention relates to a framework for automating the manual process of security monitoring and management, and more particularly to a framework that mimics the mind of a seasoned security expert and which is designed to provide security governance and compliance with business context risk assessment.

The invention is infrastructure software that enables an IT organization to effectively manage security in a complex infrastructure. By leveraging best of breed security technologies, historically treated in isolation, our proprietary workflow aggregates intelligence from across the enterprise to provide accurate, real-time detection and remediation of security events. The invention consolidates the scattered day-to-day operational functions of a security engineer into one methodical system implemented by the intelligence of the invention. This is accomplished by the proprietary process workflow

Personal computers of the early 20^{th} century mainly consisted of stand-alone units with no direct connection to other computers or computer networks. Data transfers between computers necessitated exchanging magnetic or optical media such as floppy disks. Over time, users started inter-connecting computers using Local Area Networks or “LANs”.

However, these improvements brought with them new possibilities in terms of information access and availability; simultaneously introducing new challenges in protecting Information Technology (IT) infrastructures from unwanted individuals while granting access to authorized individuals. Security and risk management have consistently ranked high on the list of concerns of top executives. Because of this, considerable investments have been made to address the challenge of preventing breaches in IT security.

The threat levels, vulnerabilities, and attacks on network security have increased over the years resulting in severe economic impacts. Meanwhile, security developments within the IT infrastructure have been relatively sluggish. However, it is widely understood that the security industry does not suffer from a lack of information or intelligence. Rather, the problem lies in that a distributed form of intelligence fails to work together to solve common problems. For example, firewalls, Intrusion Detection Systems (IDS) and other security mechanisms work independently to fight against security breaches, as opposed to coordinating their efforts. Although, most of the components needed to create an intelligent security model are available, the art of security defense, the method, the framework, the process, and an administrator to stage and conduct such a defense are essentially nonexistent.

Some of the challenges currently faced by the security industry are:

Independent vs. Collaborative Approaches

Numerous solutions to solve specific security problems have been developed. However, these solutions do not address the management of security in a collaborative framework. As a result, such independent products have created numerous single points of defense, as opposed to a real time, comprehensive defense mechanism that utilizes and unites all such components together in an organized and coordinated manner.

Inefficiency in Security Management

According to several leading Management Service Providers (MSPs), 60% of all day-to-day alerts originate from IDS logs, and 98% of these alerts are false-positives. The investment in Firewalls, IDS, Intrusion Prevention Systems (IPS), integrity suites, and the like have added undue complexity with disparate screens and monitoring consoles. In order to validate the legitimacy of a security alert, an engineer must sort through multiple sources. For example, correlating events from multiple consoles (i.e. IDS Logs, Server Logs, Firewall Logs, Router Access Control List (ACL) Logs, etc.), is time consuming and tedious. Instead of acting in a proactive manner to identify patterns of developing threats, current systems force a security team to address breaches in security after the fact, when unauthorized persons have already made an intrusion.

Lack of Security Experts

Due to constant changes in the security industry, highly trained security professionals are in constant demand. Finding the right team of engineers to keep a business environment secure requires expertise and can have a strong financial impact on a company budget. Security threats to businesses are continually increasing, and solutions to these threats must grow proportionally. Unfortunately, the number of skilled IT security professionals is not growing at the same rate. Additionally, security experts tend to work independently of each other without setting agreed upon methods. Accordingly, most IT security knowledge, acquired through years of applying intuition and experience, stays in the mind of a security engineer. Due to this lack of formal training criteria, unrefined methodologies make standardized approaches in the art of security defense impossible.

Discovering and Responding to New Security Threats/Vulnerabilities in Real-Time

Security infrastructures are constantly inundated with new vulnerabilities every hour of every day. Identifying these vulnerabilities and associating their impact in an environment is a time consuming manual process and is often prone to error. Furthermore, identifying a breach in a company's IT environment often comes too late, after the system has been compromised. In fact, it may take days, weeks, or even months to realize that security has been breached. In these cases, hackers often make a monetary demand on a company with the threat of posting confidential information on the Internet.

Real-Time Reporting vs. Yesterday's Information

Typically, security auditing has lagged behind in assessing the health of an IT environment, since audits are generally performed only once a month, and the information provided by such audits is only valid for that particular day. Since constant change is a well-known technology trend, changes are necessary to keep up with new advances. With software changes, new vulnerabilities that affect the security of a company's IT environment are invariably introduced. Monthly or even weekly audits are insufficient to assess the security health of a company's IT security system.

Change Management and its Impact on Security

Changing environments constantly introduce new threats. Changes are often made without considering system security. New nodes are frequently added into an environment without notifying security staff. Without having these new systems audited, the potential for introducing vulnerabilities into an IT environment is high. Such factors also introduce inconsistencies, compliance issues, and frequent breaches of company policy.

No Method to Review or Measure the Efficiency of Security Investment

Justifying security investment is a constant struggle for senior management of a company, since no tangible method exists to prove or provide some form of insurance that the solutions implemented will eliminate security risks. As a result, the efficiency of IT investments in security is in constant question due to the inability to effectively evaluate their effectiveness. In other words, no solution provides risk assessment from a business context.

Security is Viewed as a Technical Problem vs. a Business or Organizational Problem

Since IT security is viewed as a technical discipline, a lack of current technical understanding typically exists in the upper level management of a company. The most serious challenge today is to educate management regarding the importance of security and how it affects business. Unfortunately, there is currently no means to allow management to evaluate levels of business risk associated with an IT security breach. Mechanisms are needed to bridge the gap between a technical security expert and business minded managers. IT Security is just as much a business as computer problem, and the present invention serves as vehicle to facilitate an understanding of the importance of this.

In the prior art, there are systems, methods, machines, and software programs that relate to security monitoring. For example, U.S. Pat. No. 6,653,938 to Yang describes an automatic security enhancement system that can automatically increase the security of the system when necessary. Meanwhile, in U.S. Pat. No. 6,550,012 to Villa et al., a system and methodology providing automated or “proactive” network security (“active” firewall) are described. Further, U.S. Publn. No. 20040193912 to Li et al. describes a method comprising: detecting security information from one or more security-enabled devices; normalizing the security information; and recording the normalized security information in a data repository.

Although these inventions relate to monitoring security breaches, they do so separately and on individual threat bases. Furthermore, they fail to consider the broad range of tasks in IT security management, which include monitoring for security breaches; identifying them; alerting IT engineers; taking steps to counter the problem; and ensuring that guard against similar events in the future. The present invention accomplishes all these tasks by providing a framework that incorporates disparate IT security mechanisms into one cohesive system. This framework comprises correlation engine, risk management, trouble ticketing, security posture, threat analysis, audit, resolution and incident discovery modules.

Another object of the invention is to provide a framework designed to International Organization for Standardization (ISO) standards and Request for Comments (RFC) protocols. It is a modular system that coordinates pre-existing IT resources, and eliminates the need for entirely new systems. A further object of the invention is to provide a framework that correlates security alerts and events from separate systems to provide a global view of IT security status that identifies threat patterns as they develop.

Still another object of the invention is to provide a framework that maintains the security posture and integrity of all IT systems. This includes but is not limited to; services, versions, and revisions of software currently running in a network environment. The invention makes logical decisions, and continuously ensures the health of the system against new threats. In other words, it provides an infrastructure that constantly audits itself for security weaknesses.

These and other objects will become apparent from the accompanying drawings and the description, which follows.

### SUMMARY

A framework for automating the manual process of security monitoring and management, and more particularly, a framework that mimics the mind of a seasoned security expert which is designed to provide security governance and compliance with business context risk assessment this is described in the present invention. The framework comprises of: a correlation engine; risk management metric analyzer; trouble ticket system; security posture; threat analysis; auditing; resolution; and incident discovery modules, whereby all security mechanisms can be incorporated into one cohesive solution.

Moreover, said framework is capable of correlating alerts and events from disparate systems providing a global view of one's security status, and hence acts as a system that works to identify patterns of threat as it develops.

Further, the framework maintains the security posture of all systems. This includes but is not limited to services, versions, and revisions of software running in an environment. This allows the invention to make logical decisions that constantly validating the health of the system against newly introduced vulnerabilities, i.e., an infrastructure which constantly audits itself for weaknesses.

The scattered processes of a security engineer are consolidated into a methodical process and implemented in the intelligence of the invention. The framework simulates the daily monitoring or management tasks in the life of a security engineer.

### DRAWINGS—FIGURES

FIG. 1 illustrates an automated security monitoring and management framework of the present invention.

### DRAWINGS—REFERENCE NUMERALS

9 Database
10 Central Management Center
11 Resolution Module
12 Security Posture Module
13 Risk Analysis Module
14 Incident Discovery Module
15 Trouble Ticketing Module
16 Executive Dashboard
17 Auditing Module
18 Correlation Engine Module
19 Threat Analysis Module
20 Framework

### DESCRIPTION

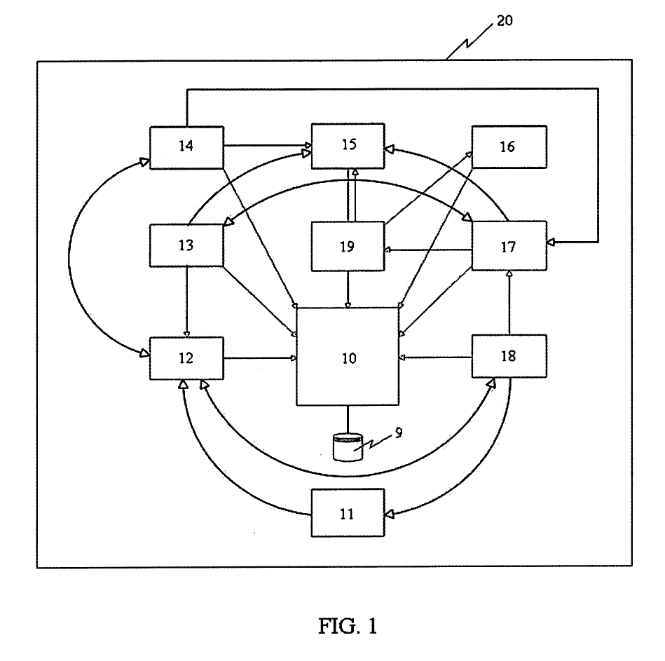

The preferred embodiments of the present invention are illustrated with the help of a block diagram as shown in FIG. 1. A framework 20 of the present invention comprises of: a central management center 10; a resolution module 11; a security posture module 12; a risk analysis module 13; an incident discovery module 14; a trouble ticketing module 15; an executive dashboard 16; an auditing module 17; a correlation engine module 18; and a threat analysis module 19. A database 9 is connected to the central management center 10 wherein a plurality of databases 9 are attached to said framework 20.

The framework 20 simulates the tasks of a security engineer by automating the day in the life cycle of a security engineer. The framework is a process workflow framework synonymous to security force automation. The framework 20 is designed to provide security governance and compliance with business context risk assessment. It intelligently behaves and reacts to security events and incidents in a cohesive fashion by using the functions of each module to provide central visibility to security management. It interacts with third party vendor products, focusing on the entire infrastructure as opposed to being specific to device or technology. It is designed to follow the International Organization for Standardization (ISO) standard and RFCs for the appropriate protocol with vendor connections. The framework 20 brings the art of security monitoring and management into a single solution.

The product of the present invention is designed to run on an appliance. Additionally the software will be capable of running on multiple operating systems.

The Central Management Center (CMC) 10 provides an administrator, visibility to the entire infrastructure and control of all modules in the framework 20. The monitoring package is designed to support monitoring protocol such as SNMPv1 (Simple Network Management Protocol), SNMPv2, SNMPv3 (RFC 1155, 1157, 1212, 1441-1452, 2263) and RMON (Remote Monitoring) (RFC 1757, 3577). A system's security pertinent information is gathered via Syslog and Microsoft event viewer as well as other log files analysis methods. The center 10 provides monitoring of CPU, Memory, Network Interfaces, Disk Statistics, System Processes, System Load and more. The center 10 is connected to all the modules in the framework 20 to provide a central point of management for the invention.

The Security Posture Module (SPM) 12 gathers hardware and software version and revision, Media Access Control (MAC) addresses of devices, Operating Systems information, IP addresses and other information into a centralized database. Incorporated in the SPM module 12 are network discovery tools and name resolution capability to uniquely identify systems throughout the environment.

The invention contains an Auditing Module (AM) 17 that constantly polls an environment for known security weaknesses. It performs audits using a differential technique to minimize network bandwidth and system resource utilization. It also has the capability of a comprehensive audit using a scheduler. The AM 17 acquires its data to perform the vulnerability audit from the Threat Analysis Module (TAM) 19. It is capable of generating trouble-tickets via the internal Trouble Ticketing Module (TTM) 15 or other third party Trouble Ticketing system. It also has alerting capability via e-mail, SNMP trap, and other electronic devices. The AM 17 has smart auditing capabilities in identifying appropriate platform and application leveraging the SPM 12. When new hosts identification is performed in the SPM 12, they are validated for compliance by the AM 17.

The Threat Analysis Module (TAM) 19 obtains up-to-date formatted security advisories and bulletins of vulnerabilities from the vendor. The data is acquired from the provider using a secure encrypted transport with authentication. The data is received on demand or at a scheduled time, and the TAM 19 compares the new information against the SPM 12 to verify if systems in the environment are affected by new known vulnerabilities. Depending on the analysis, the TAM 19 will automatically interact with the TTM 15 to generate an action item ticket for the administrator and provide the Risk Analysis Module (RAM) 13 with information to a Chief Technology Officer (CTO) or a senior executive of an organization, to make a decision with business context risk assessment for remediation.

The Executive Dashboard 16 is a portal for a senior executive of a company to view network security health and to make educated decisions to address any problems.

Risk Analysis Module (RAM) 13, which is incorporated in the framework, provides predefined metrics to analyze system risks based on revenue, loss and severity of the problem at hand. RAM reinforces individual company compliance policy and governance by empowering a decision maker to analyze and apply business impact decisions based on the severity of the threat and addressing the challenge of resource allocation. While identifying critical risk of business application, RAM helps to mitigate risk in real-time.

The framework 20 provides a Trouble Ticketing Module (TTM) 15 for the storage and tracking of existing and historic security problems. While orchestrating the coordination of IT tasks, TTM 15 keeps track of resource allocation, problem management, and historical change for correlation. All technical issues will be notified and tracked by the TTM 15, which provides an administrator with the ability to assign specific problems to the appropriate expert for faster resolution when the invention does not handle the problem via its configurable policy.

The Resolution Module (RM) 11 tends to all problems in the infrastructure. It provides the administrator with expert recommendations on how to react to specific problems with industry proven resolution processes. The knowledge base is supplied by the provider and stored in a centralized database. It is capable of performing administrative tasks at a system level—such as process and application restart. The RM 11 interacts with the TAM 19 for vulnerability resolution and integrates with connectors to third party products. The RM 11 works in conjunction with the SPM 12 to provide policy based resolution. Additionally the RM 11 works with the RAM 13 to determine course of actions based on risk metric analysis.

A Correlation Engine Module (CEM) 18, which compares all relevant security data, logs, events from disparate sources to identify the commonality in the environment, is built into the framework 20. CEM correlates events of possible threat or compromise, and works in conjunction with the TTM 15 in generating alerts, the RM 11 in addressing a resolution path, and the RAM 13 in determining risk metrics. CEM 18 will act on trends, such as PortScan, BufferOverflow and other exploits possible in an IT infrastructure. In the event of possible breach of security, CEM 18 will invoke the Computer Incident Response Procedure to identify and resolve the threat.

The industry proven methods of forensic analysis are incorporated into the Incident Discovery Module (IDM) 14. The method employed can identify the technique used by the perpetrator to compromise a system. It uses the AM 17, and SPM 12 to identify if a target system contains any vulnerability that could be exploited. Also, it queries logs; identifies Trojans, rootkit, backdoors, hidden directories and other methods to identify a hacker's toolkit. The IDM 14 will query for open Internet sockets and associate those with given applications and verify that system binaries have not been modified.

Although preferred embodiments of the present invention have been shown and described, various modifications and substitutions may be made thereto without departing from the spirit and scope of the invention. Accordingly, it is to be understood that the present invention has been described by way of illustration and not limitation.

The present invention provides a framework for automating the manual process of security monitoring and management, and more particularly, a framework that mimics the mind of a seasoned security expert and which is designed to provide security governance and compliance with business context risk assessment. With a proprietary system of metrics for risk management analysis, the present invention provides a senior executive of an organization with the ability to evaluate the efficiency of IT investment in security.

The framework comprises of: a central management center; a resolution module; a security posture module; a risk analysis module; an incident discovery module; a trouble ticketing module; an executive dashboard; an auditing module; a correlation engine module; and a threat analysis module, whereby said framework has the ability to incorporate all security mechanisms into one cohesive solution. The framework provides a collaborative approach to managing all third party independent solutions into a centralized entity. Also, the framework provides a real-time comprehensive mechanism, which enables the invention and security staff to be proactive in managing security.

Moreover, said framework is capable of correlating alerts and events from disparate systems providing a global view of security status. It easily identifies whether a threat is originating from the inside or from the outside of an environment, thereby empowering the invention, and security staff to react in real-time in addressing any security issues—in other words, a system that works to identify patterns of threat as it develops.

Further, the framework of the present invention keeps track of all systems, versions, and revisions of software running in the infrastructure, constantly validating the health of the system against newly introduced vulnerabilities, i.e., an infrastructure which constantly audits itself for weaknesses.

The scattered processes of a security engineer are consolidated into a methodical process and implemented into the invention. The framework simulates the tasks of a security engineer in order to automate a day in the life cycle of a security engineer.

Although the description above contains much specificity, these should not be construed as limiting the scope of the invention but as merely providing illustrations of some of the presently preferred embodiments of this invention. Thus, the scope of the invention should be determined by the appended claims and their legal equivalents, rather than by the examples given.

What is claimed is:

1. An automated security monitoring and management framework comprising:
(a) A central management center that provides visibility to an entire infrastructure and control of all modules in the framework;
(b) A security posture module that gathers hardware and software information into a centralized database;
(c) An auditing module that polls an environment for known security weaknesses;
(d) A threat analysis module that obtains and processes security advisories;
(e) An executive dashboard module for viewing overall network security health;
(f) A risk analysis module that provides predefined metrics to analyze system risks;
(g) A trouble ticketing module for the storage and tracking of current and historic security problems;
(h) A resolution module that analyzes and resolves problems in the infrastructure;
(i) A correlation engine module that compares data and ensures uniformity in the environment; and
(j) An incident discovery module that identifies techniques used by unauthorized persons in attempting to compromise a system.

2. The framework of claim 1, wherein said central management center supports monitoring protocols, including SNMPv1, SNMPv2, SNMPv3 (RFC 1155, 1157, 1212, 1441-1452, 2263) and RMON (RFC 1757, 3577) among others to provide visibility to the entire infrastructure and control of all modules in said framework.

3. The framework of claim 1, wherein said central management center gathers pertinent security information using Syslog, Microsoft Event Viewer and other log file analysis methods to monitor central processing units, Memory, Network Interfaces, Disk Statistics, System Processes, System Load and other information into a centralized database to provide a central point of management

4. The framework of claim 1, wherein said security posture module incorporates network discovery tools and name resolution capability to identify systems throughout the environment and gather version and revision information for installed hardware and software, Media Access Control (MAC) addresses of devices, operating system information, IP addresses and other information into a centralized database.

5. The framework of claim 1, wherein said auditing module audits said environment using a differential technique to minimize bandwidth and system resource use, contains a scheduler to perform a comprehensive audits at specified time intervals, and performs said vulnerability audits using data from said threat analysis module, causing said internal or third party trouble-ticketing system to generate trouble-tickets.

6. The framework of claim 1, wherein said auditing module identifies an appropriate platform and performs application leveraging in said security posture module, generates alerts using E-mail, SNMP trap, and other electronic devices, and validates host identification performed in said security posture module.

7. The framework of claim 1, wherein said threat analysis module obtains formatted security advisories and bulletins of vulnerabilities from providers using secure encrypted and authenticated transport at scheduled times or on demand, compares said advisories and bulletins with data from said security posture module for verification, provides said risk analysis module with information regarding said threat, and causes said trouble ticketing module to generate an action item ticket regarding said threat.

8. The framework of claim 1, wherein said executive dashboard serves as a portal for senior IT staff or other executives of a company to view overall network security and make informed decisions to address any problems that have arisen.

9. The framework of claim 1, wherein said risk analysis module produces real-time data based on predetermined criteria to analyze security risks and other system problems, allowing personnel to make decisions based on the information provided.

10. An automated security monitoring and management framework of claim 1 wherein the risk assessment module provides proprietary risk metrics to place cost on assets for business context risk analysis.

11. The framework of claim 1, wherein said trouble ticketing module tracks and stores all technical issues including security problems, allowing administrators to assign specific problems to the appropriate personnel if they are not resolved by the framework, while orchestrating the coordination of IT tasks, monitoring resource allocation, problem management, and historical changes for correlation purposes.

12. The framework of claim 1, wherein said resolution module addresses a policy based resolution path, resolves security issues, and makes recommendations regarding how to react to specific problems using known policy based resolution processes supplied by a centralized database.

13. The framework of claim 1, wherein said resolution module performs administrative tasks, including, but not limited to process and application restart functions.

14. The framework of claim 1, wherein said resolution module works with said threat analysis module to affect vulnerability resolution and integrate connectors to third party products.

15. The framework of claim 1, wherein said resolution module works in conjunction with said security posture module to provide policy based resolution.

16. The framework of claim 1, wherein said resolution module coordinates with said risk analysis module to determine a course of action based on analysis of risk metrics.

17. The framework of claim 1, wherein said correlation engine module compares relevant security data from various sources in said network to ensure uniformity in said environment.

18. The framework of claim 1, wherein said correlation engine module correlates said threat events including compromised system integrity, invokes a computer incident response procedure to identify and resolve the threat and works in conjunction with said trouble ticketing module to generate alerts.

19. The framework of claim 1, wherein said incident discovery module incorporates known and established IT industry methods of incident discovery analysis to identify techniques used by unauthorized persons in attempting to compromise said network, uses said auditing module and said security posture module to determine if said network contains any vulnerabilities that could be exploited, and queries logs; identifies Trojans, rootkit, backdoors, hidden directories and other methods used by hackers to compromise a system.

20. The framework of claim 1, wherein said incident discovery module will query for open Internet sockets, associate those with given applications and verify that system binaries have not been modified.
